(19) United States
(12) Patent Application Publication
(10) Pub. No.: US 2011/0246341 A1
(43) Pub. Date: Oct. 6, 2011

(54) SYSTEM AND METHOD FOR TAX ALLOCATION TO PARTNERS IN U.S. PARTNERSHIPS

(76) Inventor: Navendu P. Vasavada, Pittsburgh, PA (US)

(21) Appl. No.: 12/749,517

(22) Filed: Mar. 30, 2010

(51) Int. Cl. G06Q 40/00; G06Q 10/00

(52) U.S. Cl. 705/31; 705/36 T

(57) ABSTRACT

A method and apparatus are provided which allocate a U.S. partnership's pass-through items of distributive income to partners (also called “tax allocations”). Data of a partnership's distributive items of income, and partners' book and tax capital account values (these terms as defined in the Treasury Regulations) are received and an optimization including all of these data is performed to implement the partner tax allocation that are compliant with the relevant sections of the Internal Revenue Code [1] and the relevant Treasury Regulations [2, 3, 4]. Partners' distributive tax allocations provided to the partnership based on the optimization.

### BACKGROUND OF THE INVENTION

U.S. Internal Revenue Code Section 704(b) requires a partner's distributive share of income not have “substantial economic effect” [1]. Tests for tax allocations compliant with [1] are provided in the Treasury Regulations [2]. Guidelines for implementing tax allocations and related definitions are provided in the Treasury Regulations [3,4,5], which henceforth are referred to as the “relevant Treasury Regulations”. [NOTE: Literature references cited herein are given in full at the end of the specification.]

Most U.S. partnerships allocate distributive items of income to partners according to a computationally intensive procedure commonly known as “layering,” that corresponds to the example provided in the Treasury Regulations [3], to make allocations the items of taxable realized income other than realized capital gains. When this method is applied to make tax allocations of realized capital gains, the computational burden increases greatly, due to having to track and allocate realized gains of every tax lot that is traded by the partnership. Nevertheless, many U.S. partnerships apply this method to make tax allocations of realized capital gains.

Several U.S. partnerships adopt a mixed mode, of making tax allocations of distributive items of income other than realized capital gains according to the procedure of layering, and of making tax allocations of realized capital gains according to the full or partial netting approaches described in the Treasury Regulations [4,5], the latter in ways that might be arbitrary and widely at variance.

The present art is based on arbitrary rules for making tax allocations under full and partial netting. A representative example of the present art [6] is based on allocating losses to loss-making partners and gains to gain making partners, without identifying an explicit measure of book-tax disparities of the partners, or any indication whether such book-tax disparities may be reduced further.

This invention improves the current state of art of determining partnership tax allocations by providing a system and fast automated method for determining a unique and robust automated optimal tax allocation solution, thus dispensing with arbitrariness, variability and non-uniformity that is extant in the present art, while conforming fully to the Treasury Regulations.

A partner's economic liquidation value in a partnership is understood to be the partner's “book capital account value”, and the tax basis of the partner's interest in a partnership is understood to be the partner's “tax capital account value” in the context of the relevant Treasury Regulations.

The relevant Treasury Regulations for Partial and Full Netting, respectively, require that the allocation of taxable items of income be made so as to reduce the book-tax disparities of the individual partners.
“ . . . (the partnership) allocates the aggregate tax gain and aggregate tax loss to the partners in a manner that reduces the disparity between the book capital account balances and the tax capital account balances (book-tax disparities) of the individual partners.” [4]

Neither the relevant Treasury Regulations not the present or prior art encompass a distinct metric to represent the book-tax disparities of the individual partners. The present invention establishes a family of distinct metrics to objectively represent collective book-tax disparities of the individual partners. These metrics and related embodiments contained in the methods of claims 1, 2, and 3 achieve an optimal, robust and unique allocation that not just reduces the book-tax disparities of the individual partners, as extant in the current art, but instead reduces the book-tax disparities of the individual partners to a global minimum book-tax disparities of the individual partners through a fast automated system and method.

The methods of claims 1 and 2 enable a partnership to implement fast, efficient and optimal tax Treasury-compliant tax allocations of realized capital gains to partners by the approaches of full and partial netting, respectively. Such partnerships may adopt a mixed mode, of adopting the method of layering for allocating distributive items of ordinary income, such as dividends, interest and expenses, and the approach of full or partial netting for the allocation of realized capital gains.

The method of claim 3 generalizes the methods of claims 1 and 2 by allocating all distributive items of partnership income to partners, which include not only the distributive items of realized and unrealized capital gains, but also distributive items of ordinary income, dividends, interest and expenses. Such tax allocation is made by automated method in a computer system, resulting in a single optimal, robust, unique and reproducible tax allocation solution.

### SUMMARY OF THE INVENTION

The object of the present invention to provide a system and method that makes fast automated tax allocations of items of a partnership's distributive items of income to partners so that the collective book-tax disparities of the individual partners are minimized in a manner that is fully consistent and compliant with the relevant Treasury Regulations.

It is another object of the present invention to provide a metric or measure of the book-tax disparities of the individual partners that is to be minimized, that is a convex function of the tax allocations to be determined by the present invention, such metric absent in the prior and present art and in the relevant Treasury Regulations.

It is another object of the present invention to establish relevant constraints and restrictions under which such minimization is to be conducted, leading to the formulation of a convex optimization problem that seeks to minimize, by choice of tax allocations, a convex measure of the book-tax disparities of the individual partners, subject to linear constraints thus established, such formulation of a convex optimization problem absent in the present and prior art.

It is another object of the present invention to provide a global minimum of book-tax disparities of the individual partners according to the same objective measure in the context of the input data, and not provide a tax allocation from among a plurality of local minima of such book-tax disparities the individual partners.

It is another object of the present invention to provide a system and method to select amongst a plurality of tax allocations, all of which achieve the same global minimum of book-tax disparities of the individual partners, and produce a unique and robust partner tax allocation solution that is fully consistent and compliant with the relevant Treasury Regulations.

It is another object of the present invention not to require a user or partnership to provide an initial starting tax allocation to partners, and that the system and method provided will proceed to deliver the optimal solution without such an initial starting point.

It is another object of the present invention to provide unique, robust and optimal solutions for tax allocation of realized capital gains and losses only according to the Full Netting and Partial Netting approaches described in the relevant Treasury Regulations. The partnership would independently determine the tax allocations to partners of taxable distributive items of income such as ordinary income, dividends, interest and investment expenses and factor these into the input data.

It is another object of the present invention to provide unique, robust and optimal solutions for tax allocation of all taxable distributive items of income, including realized capital gains and losses, ordinary income, dividends, interest and investment expenses according to the Full Netting and Partial Netting approaches described in the relevant Treasury Regulations.

In accordance with one aspect of the present invention, a method is provided for determining partner tax allocations in a system which includes a computing device, comprising the steps of: identifying the partnership's taxable distributive items of income to be allocated to partners; receiving the partnership's information on each partners book and tax capital accounts as defined in the relevant Treasury Regulations; performing an optimization on the data for the partnership's taxable distributive items of income and the data for book and tax capital accounts of the individual partners in the computing device; and displaying the tax allocation of the partnership's taxable distributive items of income that minimize the book-tax disparities of the individual partners.

These and other objects, features, procedures, methods and advantages will become evident and clear when considered with reference to the following description and the accompanying drawings.

### BRIEF DESCRIPTION OF THE DRAWINGS

FIG. 1 is a flow chart which depicts an overview of the data input and the two-step optimizer features and the unique, robust and optimal tax allocation output of the present invention.

### DETAILED DESCRIPTION OF THE EMBODIMENTS

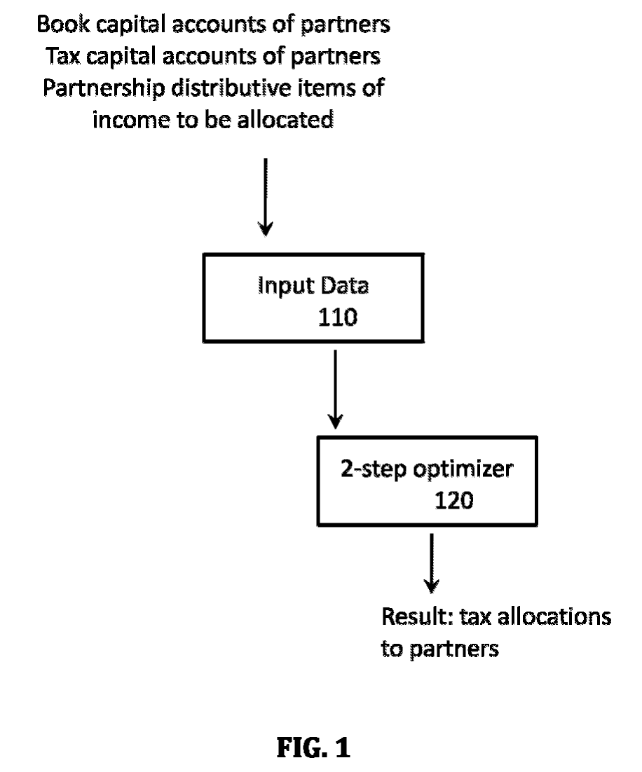

Referring now to FIG. 1, an embodiment of the present invention will now be described in greater detail. In accordance with the present invention, several functional areas are employed. Data are gathered in block 110, including data on the partnership's items of taxable distributive income that is to be allocated to partners, and data regarding book-tax disparities of the individual partners that are extant before the tax allocation is conducted.

The Two Step Optimizer block 120 uses the data from the input data block 110, and implements its first step by embodying the convex optimization tax allocation problem according to the method of the present invention, and applies convex optimization techniques of the art to determine determines the envelope of optimal allocation solutions that all achieve a global minimum of collective book-tax disparities of the individual partners.

The second step of block 120 consists of providing the results of the first step as input, in addition to the inputs available from block 110, and embodies the convex optimization problem according to the method of the present invention, and determine a unique and robust tax allocation solution from within the envelope of optimal solutions of the first step. This is the final result of relevance to the partnership and its partners.

The above functional blocks will be described in greater detail in the following sections.

### Setting Up the Optimization Problem for Tax Allocation of Realized Capital Gains Under Full Netting

A key feature of any tax allocation optimizer is that the book-tax disparities of the partners is reduced to a minimum, taking into consideration each of the partner's respective book and tax capital accounts, and the total taxable items of income of the partnership to be allocated to the partners. There are different approaches to setting up the optimization problem for this case, including various heuristic approaches that attempt to reduce such disparities. One embodiment is illustrated in this section. It will be apparent to those who have ordinary skill in the art that there are alternate ways to set up the optimization. What is common to these methods is that each requires tax allocation of items of partnership income in a manner so as to reduce the book-tax disparities defined in a number of different ways. The approach to partner tax allocation problem adopted in this embodiment is to represent the book-tax disparities of the partners according to a family of convex mathematical functions that map the multi-dimensional space of tax allocations to a one-dimensional space of book-tax disparities. Further, the constraints that are operative are identified and found to be linear mathematical relationships involving the tax allocation decision vector. Further, the class or family of such convex objective functions subject to linear constraints is known to those with skill in the art to have a global minimum, and that there are extant several optimizers in the form of software and published algorithms to achieve such a global minimum.

The nature of the tax allocation optimization problem is that, while a global optimal minimum to the book-tax disparities indeed exists and may be uncovered by convex optimization methods available to those with skill in the art, there is a multitude of tax allocation vectors that achieve the same global minimum. The art neither identifies such plurality of tax allocation solutions, not provides approaches to select a robust and unique tax allocation solution within this multitude. The embodiment of the present invention illustrated in this section demonstrates how a two step convex optimization method is established, in which the first step identifies the envelope of the multitude of tax allocation solutions according to one convex objective function, and the second step according to a different convex objective function, while constraints in both steps prevail, and the second step has additional constraints that narrow the search to the envelope of the multitude of tax allocation solutions of the first step.

The present invention thus bridges the relevant Treasury Regulations [4,5] to provide a system and method of two step convex optimization problem subject to linear constraints, from which a unique and robust tax allocation solution that also is a global minimum emerges, by applying convex optimization methods of the art.

In the remainder of this section, the specific steps taken to set up a tax sensitive portfolio optimization are outlined for making tax allocations of net short term and long term realized gains only, according to the approach of Full Netting [4]. The present invention constructs a measure of the “book-tax disparities of the individual partners” corresponding to language provided in the relevant Treasury Regulations [4,5], that is described here. The partnership has M partners. The objective is to allocate two items of realized capital gains at the partnership level to partners: short term realized capital gains, denoted by Π₈, and long-term realized capital gains, denoted by Π₉ₐ, to each of the M partners, at the time point at which the partnership closes its tax year for tax reporting purposes, which is usually the end of a calendar year for most partnerships. The tax allocation of Π₈ and Π₉ₐ at the partnership level allocated to each partner, represented by the superscript index j, are denoted as Π₈^{j} and Π₉ₐ^{j}.

In this embodiment, tax allocations of other concurrent items of gains and losses, such as dividends, interest and expenses are made to partners according to the method of layering described in the relevant Treasury Regulations [3]. The tax capital account of a partner encompasses all cumulative distributive items of income, deposits and withdrawals that are summed up leading to the calculation of calculation of the partner's tax basis. Distributive items of income may not be taxable, such as tax-exempt interest. Similarly, distributive non-cash expenses of a partnership such as depreciation might be a tax deductible expense for a partner. The partner's tax basis does not include unrealized capital gains. Partners are expected to track their tax basis denoted by κ^{j}, so that when they entirely dispose of their partnership interest receiving a sale or liquidation amount denoted by U^{j}, the difference denoted by U^{j}−κ^{j} is required to be reported by them in their individual tax return as realized capital gain.

We provide, as input data to this embodiment, each partner's book capital account value U^{j}, which is calculated by the partnership according to the definitions in the relevant Treasury Regulations. A partner's economic interest in the partnership U^{j} represents all allocations of economic income without regard to taxable nature, with the exception of unrealized capital gains, and all deposits and withdrawals. This also represents the hypothetical economic liquidation claim of a partner at any point in time. We also provide as input each partner's tax capital account κ^{j}, which for each partner represents the tax basis before the allocation of realized capital gains Π₈^{j} and Π₉ₐ^{j}, which is also calculated by the partnership according to the definitions in the relevant Treasury Regulations. A partner's tax capital account κ^{j} for this system and method includes all deposits and tax allocations made in prior years, all current year tax allocations of taxable income other than realized capital gains, but excludes any tax allocations of realized capital gains for the current year, Π₈^{j} and Π₉ₐ^{j}, which are to be determined by the present invention.

Neither a partner's book capital account tax U^{j} nor the tax capital account κ^{j} for this system and method include deposits or withdrawals made at the close of the partnership's tax filing period, at the time point where U^{j} is measured. The present invention calculates and accepts as input data the book-tax difference before realized capital gains allocations for each partner, denoted by ρ^{j}=U^{j}−κ^{j}. U^{j} and κ^{j} are fixed constant input data known for the relevant tax allocation determination time point, and hence ρ^{j} is a known constant input data, for each of the partners.

Given M partners in a partnership, we have a set of 2M tax allocation variables {Π₈^{j}, Π₉ₐ^{j}} for j=1 . . . M partners is written as a vector x=[(Π₈¹, Π₉ₐ¹), (Π₈², Π₉ₐ²), . . . , (Π₈^{M}, Π₉ₐ^{M})]. This is a column vector of length 2M, of the tax allocation outcomes to be determined by the present invention, whose elements are ordered pairs of the short-term gain allocation Π₈^{j} and the long-term gain allocation Π₉^{j}.

We define a M by 2M coefficient matrix

$${H}_{1} = [ \begin{matrix}{E}_{1} & ⋯ & {Z}_{1} \\ ⋮ & ⋱ & ⋮ \\ {Z}_{1} & … & {E}_{1}\end{matrix} ]$$

has the vector E₁=[1 1] along its diagonals, and Z₁=[0 0] at all off-diagonal places. We define g₁=[ρ¹, ρ₂, . . . , ρ^{M}] as a column vector of length M, whose elements are the ρ^{j}.

The present invention constructs a column vector of the book-tax disparities of the individual partners as g₁−H₁x. The elements of this vector are [(ρ¹−Π₈¹−Π₉ₐ¹), (ρ²−Π₈²−Π₉ₐ²), . . . , (ρ^{M}−Π₈^{M}−Π₉ₐ^{M})].

The present invention pivotally rests on two steps. The first step consists of constructing a convex objective function that maps the vector g₁−H₁x of book-tax disparities of the individual partners of dimension 2M to a scalar one-dimensional real number value that is interpreted as the collective scalar single value measure of book-tax disparities of the partners. This convex function is represented as ƒ(g₁−H₁x), to be reduced or minimized by choice of appropriate tax allocation vector x, as required by the relevant Treasury Regulations. This function ƒ(x) maps tax allocations x belonging to a hyperspace of real numbers of dimension 2M, R^{2M}, to the real number space of dimension 1, R¹.

The present invention is based on identifying a family of convex functions ƒ(x) to represent and map collective book-tax disparities, denoted as ƒ(x)=∥g₁H₁−x∥ₚ, p≧1. This family of functions known in the art as the p-norm of a vector, with p≧1. In its expanded form, the collective measure of book-tax disparities is written as:

$$f ( x ) = {[ {\sum }_{j = 1}^{M} {\vert {ρ}^{j} - ( {\prod }_{8}^{j} + {\prod }_{9}^{j} ) \vert}^{p} ]}^{\frac{1}{p}} , p \geq 1.$$

One skilled in the art will appreciate that various modifications or applied examples of convex objective functions to measure the book-tax disparities of the partners are conceivable which are within the scope of this invention, that include higher q-powers of the p-norm, (∥g₁−H₁x∥ₚ)^{q}, q≧1. One skilled in the art will also appreciate that the Euclidean distance between the vector of book capital account values g₁ and the tax capital account values H₁x of partners is the 2-norm, written as ∥g₁−H₁x∥₂ and is often written as ∥g₁−H₁x∥ with the subscript 2 omitted. The method and its embodiments of the present invention are based on the selecting the 2-norm, without any loss of generalization.

Some other interesting norms arise for specific values of p. With p=1, the 1-norm is interpreted as the sum of absolute disparities. With p tending to infinity, the infinity norm is the maximum element in the argument vector. The quadratic objective function is the square of the 2-norm and is the basis of quadratic programming.

While there may be some concern that a plurality of optimal solutions may arise depending on different specifications of the objective function, those familiar with the art are aware of the property that the optimal solution to the p-norm convex objective function is invariant to additive, multiplicative and some power transformations. The optimal value of the objective function would indeed vary, but the optimal solution remains the same. For instance, the tax allocation solution x for ƒ(x)=∥g₁−H₁x∥ is the same as that for ƒ₂ (x)=[ƒ(x)]² p-norm family thus presents a robust class of functions for the embodiments of the present invention.

One skilled in the art will appreciate that there are other convex objective functions that would suitably represent the collective book-tax disparities of the partners, such as the logarithm sum of exponentials of the disparities: ƒ(g₁−H₁x)=log [Σⱼ₌₁^{M}e[^{ρ}^{^{j}}^{-(Π}^{₈}^{^{j}}^{+Π}^{₉}^{^{j}}^{)]}]

We demonstrate one specific embodiment of a convex objective function from a family of such functions, the 2-norm or Euclidean distance measure of the collective book-tax disparities of the partners as ƒ(x)=∥g₁−H₁x∥. We now establish the constraints under the procedure of Full Netting that restrain this objective function.

All partner tax allocations Π₈^{j} and Π₉ₐ^{j}, for j=1 . . . M, must satisfy one of the following two constraints, depending on whether aggregate realized short-term gains Π₈ are negative or positive:

Π₈≦Π₈^{j}≦0 when Π₈≦0, or

Π₈≧Π₈^{j}≧0 when Π₈≧0.

Similarly, they must satisfy one of the following two constraints, depending on whether aggregate realized long-term gains Π₉ are negative or positive:

Π₉ₐ≦Π₉ₐ^{j}≦0 when Π₉ₐ≦0, or

Π₉ₐ≧Π₉ₐ^{j}>0 when Π₉ₐ>0.

Though there are four equations above, there are only two effective constraints that become operative according to the sign of Π₈ and Π₉ₐ. We shall call these two the magnitude constraints. Also, note that each equation has two inequalities.

The two magnitude constraints above mean that:
(1) When there are aggregate realized losses at the partnership level, no partner may be allocated gains, and vice versa, when there are aggregate realized gains at the partnership level, no partner may be allocated losses.
(2) The absolute value of the aggregate realized losses or gains have to exceed the partner allocations. Thus, when the partnership makes aggregate losses, no partner may be allocated losses that exceed the aggregate losses.

Further, the realized gain tax allocations are subject to the two constraints that represent the meaning of the word “allocation”:

Σⱼ₌₁^{M}Π₈^{j}=Π₈ and

Σⱼ₌₁^{M}Π₉ₐ^{j}=Π₉

These two constraints ensure that the short-term realized gain tax allocations must add up to the total short-term gains for the partnership, and likewise for long-term gains. These two constraints reflect the requirement in the relevant Treasury Regulations to preserve the nature of gains when making allocations under full or partial netting.

The two additivity constraints simplify the two magnitude constraints as previously stated. The magnitude constraints, after factoring the additivity constraints into them, are reduced and simplified as follows:

Π₈^{j}≦0 when Π₈≦0, or Π₈^{j}>0 when Π₈>0 (there are M such constraints applying on allocation of realized short-term capital gains Π₈.)

Π₉ₐ^{j}≦0 when Π₉ₐ≦0, or Π₉ₐ^{j}>0 when Π₉ₐ>0 (there are M such constraints applying on allocation of realized long-term capital gains Π₉ₐ.)

### The First Step Convex Optimization Solution Identifies an Envelope of Optimal Tax Allocations

We state our the first step of our convex optimization problem for obtaining partner tax allocations under Full Netting as:

min.ₓ ƒ(x)=∥g₁−H₁x∥ which may also be expanded as:

min._{{Π}_{₈}_{^{k}}_{,Π}_{₉ₐ}_{^{j}}_{}}{Σⱼ₌₁^{M}[ρ^{j}−(Π₈^{j}+Π₉^{j})]²}^{1/2}

subject to feasibility constraints that:

Π₈^{j}≦0 when Π₈≦0, or Π₈^{j}>0 when Π₈>0 (M such magnitude constraints)

Π₉ₐ^{j}≦0 when Π₉ₐ≦0, or Π₉ₐ^{j}>0 when Π₉ₐ>0 (M such magnitude constraints)

Σⱼ₌₁^{M}Π₈^{j}=Π₈, and Σⱼ₌₁^{M}Π₉ₐ^{j}=Π₉, (2 such additivity constraints)

We have 2M unknowns, {Π₈^{j}, Π₉ₐ^{j}} for j=1 . . . M, that we have to solve for, subject to 2M+2 constraints.

The art guarantees that there exists a global optimum to a convex objective function subject to linear constraints, and that the solution to achieve this global optimum can be obtained by quadratic programming and other convex programming algorithms. However, the present tax allocation problem has a peculiarity, that there are multiple solutions in all of its embodiments, each of which satisfies the feasibility constraints, and each of which evaluate to the same global minimum of collective book-tax disparities of the partners.

We provide an understanding as to why this plurality occurs. We examine the first-order conditions of optimality for unconstrained minimization, disregarding the feasibility constraints. Our tax allocation solution vector x has 2M elements. We take the derivative of ƒ(x) with respect to each of the 2M elements and set it to equal zero, which is the first-order condition for an unconstrained optimum. We obtain 2M such first-order conditions. However, only M of them are distinct. Take, for instance, the derivative of ƒ(x) with respect to Π₈^{j}, which is −2 [ρ^{j}−(Π₈^{j}−(Π₈^{j}+Π₉ₐ^{j})]. This is identical to the derivative of ƒ(x) with respect to Π₉ₐ^{j}, which is also −2 [ρ^{j}−(Π₈^{j}+Π₉ₐ^{j})].

At the global minimum for ƒ(x) in the first step convex optimization problem, which we denote as ƒ(x*), and all of the optimal solutions x* have the property that (Π₈^{*j}+H₉ₐ^{*j})=Π₈₊₉ₐ^{**j}. The elements (Π₈^{*j}, Π₉ₐ^{*j}) may vary across the different solutions to produce the same unique global optimum ƒ(x*), but the sum of this pair (Π₈^{*j}, Π₉ₐ^{*j}) adds up to a unique number Π₈₊₉ₐ^{**j} across all solutions. Thus, ƒ(x*) is a global minimum value for all the optimal solutions x* with varying elements (Π₈^{*j}, Π_{Iƒ9a}^{*j}). Stated differently in matrix notation, the multiplicity of optimal solutions x* have the property that H₁x* is invariant. The elements of H₁x* are such that (Π₈^{*j}+Π₉ₐ^{*j})=Π₈₊₉ₐ^{**j}, where Π₈₊₉ₐ^{**j} is invariant across all solutions. This envelope of optimal solutions is factored into the constraint set in the second step of the present invention. The proof of this invariance of H₁x* with its elements Π₈₊₉ₐ^{**j} is discernable to one familiar with the art and arises due to the 2M first-order conditions to the unconstrained optimum collapsing into M distinct first order conditions. Due to this redundancy, one may solve only for M distinct and unique elements, which are represented by the vector H₁x*. Thus the first step of convex optimization subject to linear constraints produces a solution x* provides a global minimum ƒ(x*), and a condition that all optimal solutions must satisfy, that H₁x* is invariant. His condition, that H₁x* is invariant, is presented as a constraint in the second step, described below.

The first step convex optimization of the present invention is embodied into code that obtains the optimum solution x*, the global minimum ƒ(x*), and the invariant envelope of optimal solutions H₁x* by deploying open source convex optimization software of the art. The preferred embodiment is with a user-friendly convex programming front-end software named CVX [7], which provides a user-friendly interface and checks the formulation according to its methodology of disciplined convex programming. CVX in turn invokes the open source convex optimization algorithm named SDPT3 [8] which is its default solver. SDPT3 is based on the art of solving the convex optimization programs based on a modern approach known as interior point methods, which provide scalability, fast convergence and a mathematical certificate that the optimal solution provided is indeed a global optimum, through simultaneously providing the solution to the Lagrange dual problem to the original convex optimization problem [9]. With such certificate of optimality, and armed with proof that the objective function is indeed convex through the positive semi-definite nature of its associated Hessian matrix described earlier, we have complete assurance that the proposed optima solution obtained from SDPT3 is indeed a global minimum.

### The Second Step Convex Optimization Solution Narrows Down Tax to One Unique and Robust Solution

The present invention establishes a simple criterion that the unique and robust tax allocation solution should meet. Here is a numerical example. Suppose the first-pass optimal solution allocated {Π₈^{*j}, Π₉ₐ^{*j}}={−32,33} to a given partner so that (Π₈^{*j}+Π₉ₐ^{*j})=Π₈₊₉ₐ^{**j}=+1. Suppose another optimal solution allocates {Π₈^{@j}, Π₉ₐ^{@j}}={−1,2} to the same partner so that the sum total is also +1. We would prefer the second allocation and would consider the first allocation to be exaggerated, or tilted according to tax preferences of some the partners.

We want the scaled values of partner tax allocations, each scaled by their (unique) optimal total allocation Π₈₊₉ₐ^{**j}, which are the elements of H₁x* from the first step, to be the lowest across partners. Mathematically, we would like the 2-norm of the scaled optimal solution, interpreted as its Euclidean length, to be the minimum within the envelope of optimal tax allocation solutions.

In the first step, the vector x represented the tax allocations of partners. In the second step, the tax allocation vector is denoted by z, so as to distinguish it from x. We now need to scale z, by dividing each element by the respective partner's optimal tax allocation Π₈₊₉ₐ^{**j} that was derived from the optimal solution x* in the first pass. We define a scaling a vector, denoted as xopt2, of length 2M, as follows: xopt2={(Π_{8+9 a}^{**1}, Π₈₊₉ₐ^{**1}), (Π₈₊₉ₐ^{**1}, Π₈₊₉ₐ^{**1}), . . . , (Π^{8+9a}^{**M}, Π₈₊₉ₐ^{**M})}.

In compact matrix form, we may derive the vector xopt2=Hx*, where x* is an optimal tax allocation solution obtained in the first step, and the matrix

$$H = [ \begin{matrix}E & ⋯ & Z \\ ⋮ & ⋱ & ⋮ \\ Z & … & E\end{matrix} ]$$

where E is a 2×2 matrix of ones along the diagonal, and Z is a 2×2 matrix of zeros at all other off-diagonal positions. Thus,

$$E = ( \begin{matrix}1 & 1 \\ 1 & 1\end{matrix} ) and Z = ( \begin{matrix}0 & 0 \\ 0 & 0\end{matrix} ) .$$

The matrix H is one-half times the Hessian corresponding to the convex objective functions of the p-norm family. Its positive semi-definite nature establishes proof that the proposed objective function is convex, and thus we are guaranteed that a global minimum to the constrained convex optimization problem exists.

We scale our decision vector z by dividing each element of z by the corresponding element of xopt2. Consistent with coding notation in the art for scaling vector elements, we shall denote this as (z)./(xopt2). The ./operator divides the first element of z by the first element of xopt2, and so on. The second step objective function is to choose z so as to minimize ƒ₂(z)=∥(z)./(xopt2)∥, that is, we wish to find z with the smallest scaled 2-norm that belongs to the envelope of first step optimal solutions. Note that the vector xopt2, which was obtained from the first step solution x*, is a fixed parameter for the second step.

The original feasibility constraint set is extended by placing additional constraints that require the second step optimal solution to belong to the envelope of optimal solutions defined by the first step. For M−1 partners, we establish the vector xopt1={Π₈₊₉ₐ^{**j}} with j=1 . . . M−1 elements. Note that xopt1 collapses the repeated elements in xopt2, but skips the last partner. The vector xopt1 is same as the first M−1 elements of the vector H₁x* from the first step. Alternately, each element of xopt1 is Π₈₊₉ₐ^{**j}, which is determined from the first step optimal solution as Π₈₊₉ₐ^{**j}=(Π₈^{*j}+Π₉ₐ^{*j}).

The additional constraints that persuade the optimal solution z={Π₈^{j}, Π₉ₐ^{j}} to belong to the envelope of optimal solutions produced by the first step are:

Π₈^{j}Π₉ₐ^{j}=Π₈₊₉ₐ^{**j} for j=1 . . . (M−1) (there are (M−1) such constraints).

We denote the matrix H₂ as the same as H₁ as defined under the first step, with its last row omitted, making H₂ a matrix with M−1 rows and M columns. This constraint set is written in matrix form as H₂z=xopt1.

The second step convex optimization problem to determine a unique and robust tax allocation solution that also minimizes the collective book-tax disparities of the partners is stated as:

$${min}_{x} . {f}_{2} ( z ) = ‖ z . / xopt 2 ‖$$

where, is the z is the tax allocation vector of length 2M,

z=[(ø₈¹, Π₉ₐ¹), (Π₈², Π₉ₐ²), . . . , (Π₈^{M}, Π₉ₐ^{M})];

The same 2M+2 constraints as in the first step apply:

Π₈^{j}≦0 when Π₈≦0, or Π₈^{j}>0 when Π₈>0 (M such magnitude constraints)

Π₉ₐ^{j}≦0 when Π₉ₐ≦0, or Π₉ₐ^{j}>0 when Π₉ₐ>0 (M such magnitude constraints)

Σⱼ₌₁^{M}Π₈^{j}=Π₈, and Σⱼ₌₁^{M}Π₉ₐ^{j}=Π₉, (2 such additivity constraints)

Π₈^{j}+Π₉ₐ^{j}=Π₈₊₉ₐ^{**j} for j=1 . . . (M−1) which is also expressed compactly in matrix form as: H₂z=xopt1.

This embodiment in the second step produces an optimal tax allocation vector z* which is unique, robust, and optimal, being the tax allocation vector of the smallest scaled Euclidean length that belongs to the envelope of optimal solutions determined in the first step. vector z* based on the interior point algorithm of the art, and providing a certificate of optimality that verifies that the optimum solution is a global minimum.

The convex optimization problem for partial netting has a similar structure as that for full netting. Under full netting with M partners, we have 2 items of realized gains at the partnership level to be multiplexed into 2M tax allocation numbers. Under partial netting for the same M partners, we have 4 items of realized gains to be multiplexed into 4M tax allocation numbers. These 4M tax allocations are to be solved for in a similar manner as in full netting, in two steps. Π_{8,G}Π_{8,L}Π_{9a,G}Π_{9a,L} The subscripts L and G denote loss-making tax lots and gain-making tax lots, each partially aggregated, respectively. The subscripts 8 and 9a, represent short-term and long-term realized capital gains, respectively. We denote our vector of 4M tax allocations to be solved for as x={Π_{8,L}^{j}, Π_{a,L}^{j}, Π_{8,G}^{j}, Π_{9a,G}^{j}} for M partners j=1 . . . M. Our tax allocation decision vector x has 4M elements, 4 for each partner.

We represent our objective function the collective measure of book-tax disparities of the partners, as:

$$f ( x ) = ‖ {H}_{1} x - {g}_{1} ‖ , where {H}_{1} = [ \begin{matrix}{E}_{1} & ⋯ & {Z}_{1} \\ ⋮ & ⋱ & ⋮ \\ {Z}_{1} & … & {E}_{1}\end{matrix} ]$$

is an M by 4M coefficient matrix containing the length 4 row vectors E₁=[1 1 1 1] along its diagonals, and Z₁=[0 0 0 0] at all off-diagonal locations.

We are given the column vector g₁ in advance, of each partner's book-tax difference before making the tax allocations of the 4 partially aggregated items of realized gain, but after making allocations of other items of taxable income according to the layering methodology [3]. The input data vector g₁ has M elements. The elements of our vector g₁ of length M are:

g₁^{T}=[ρ¹ ρ² . . . ρ^{M}].

The first step convex optimization to solve for tax allocations of partially netted realized capital gains in this embodiment is stated as:

$${min}_{x} . f ( x ) = ‖ {H}_{1} x - {g}_{1} ‖ ,$$

which is written in expanded form as:

min._{Π}_{_{8,L}}_{^{j}}_{,Π}_{_{9a,L}}_{^{j}}_{,Π}_{_{8,G}}_{^{j}}_{,Π}_{_{9a,G}}j[Σⱼ₌₁^{M}{ρ^{j}−(Π_{8,L}^{j}+Π_{9a,L}^{j}+Π_{8,G}^{j}+Π_{9a,G}^{j})}²]^{1/2}

subject to the feasibility constraints that:

Π_{8,G}^{j}≧0 (M such constraints)

Π_{8,L}^{j}≦0 (M such constraints)

Π_{9a,G}^{j}≧0 (M such constraints)

Π_{9a,L}^{j}≦0 (M such constraints)

and subject to the four aggregation constraints that:

Σⱼ₌₁^{M}Π_{8,G}^{j}=Π_{8,G}

Σⱼ₌₁^{M}Π_{8,L}^{j}=Π_{8,L}

Σⱼ₌₁^{M}Π_{9a,G}^{j}=Π_{9a,G}

Σⱼ₌₁^{M}Π_{9a,L}^{j}=Π_{9a,L}

We have 4M unknowns to be solved for, subject to 4M+4 constraints. This embodiment for partial netting provides the tax allocation solution vector x*, which is one of the many such vectors that achieves the global minimum of book-tax disparities ƒ(x*). The multiplicity of tax allocation vectors x* that globally minimize ƒ(x*) have the property that H₁x* is invariant,

In the second step, the tax allocation vector is denoted by z, so as to distinguish it from x in the first step. We now need to scale z, by dividing each element by the respective partner's optimal tax allocation Π_{8,G+8,L+9+,G+9a,L} that was derived from the optimal solution x* in the first step. In compact matrix form, we may derive the length 4M scaling vector xopt2=Hx*, where x* is an optimal tax allocation solution obtained in the first step, and H is the block diagonal matrix

$$H = [ \begin{matrix}E & ⋯ & Z \\ ⋮ & ⋱ & ⋮ \\ Z & … & E\end{matrix} ]$$

where E is a 4×4 matrix of ones along the block diagonal, and Z is a 4×4 matrix of zeros at all other block off-diagonal positions. H is also one-half times the Hessian corresponding to our convex objective function, and its positive semi-definite nature is proof of convexity of the objective function.

We scale our decision vector z by dividing each element of z by the corresponding element of xopt2. Consistent with coding notation in the art for scaling vector elements, we shall denote as (z)./(xopt2). The ./operator, introduced previously, divides the first element of z by the first element of xopt2, and so on. The second step objective function is to choose z so as to minimize ƒ₂(z)=∥(z)./(xopt2)∥, that is, we wish to find z with the smallest scaled 2-norm that belongs to the envelope of first step optimal solutions. Note that the vector xopt2, which was obtained from the first step solution x*, is a fixed parameter for the second step.

The original feasibility constraint set is extended by placing additional constraints that require the second step optimal solution to belong to the envelope of optimal solutions. For M−1 partners, we establish the vector xopt1={Π_{8,G+8,L+9a,G+9a,L}^{**j}} with j=1 . . . M−1 elements. Note that xopt1 collapses the repeated elements in xopt2, but skips the last partner. Each element of xopt1 is Π_{8,G+8,L+9a,G+9a,L}^{**j}, which is determined from the first step optimal solution as (Π_{8,G}^{/j}+Π_{8,L}^{*j}+Π_{9a,G}^{*j}+Π_{9a,L}^{*j}. In matrix notation, the vector xopt1 is identical to H₁x* with the last row omitted.

The additional constraints that define an envelope of first step optimal solutions that must be satisfied by any second step optimal solution z={Π_{8,G}^{j}, Π_{8,L}^{j}, Π_{9a,G}^{j}, Π_{9a,L}^{j}} are:

Π_{8,G}^{j}+Π_{8,L}^{j}+Π_{9a,L}^{j}=Π_{8,G+8,L+9a,G+9a,L}^{**j} for j=1 . . . (M−1) (there are (M−1) such constraints).

The second step convex optimization problem to determine a unique and robust tax allocation solution that also minimizes the collective book-tax disparities of the partners is stated as:

$${min}_{x} . {f}_{2} ( z ) = ‖ z . / xopt 2 ‖$$

where, is the z is the tax allocation vector of length 4M,

z={Π_{8,L}^{j}, Π_{9a,L}^{j}, Π_{8,G}^{j}, Π_{9a,G}^{j}}

The same 4M+4 constraints as in the first step apply, and these are not repeated here.

(Π_{8,G}^{j}+Π_{8,L}^{j}+Π_{9a,G}^{j}+Π_{9a,L}^{j}). for j=1 . . . (M−1). This represents M−1 constraints, which may also be expressed compactly in matrix form as:

H₂z=xopt1

H₂ above is H₁ as defined under the first step, with its last row omitted, making H₂ a matrix with M−1 rows and M columns

This embodiment in the second step produces an optimal tax allocation vector z* that represents tax allocations of realized capital gains under the method of partial netting which is unique, robust, and optimal, being the tax allocation vector of the smallest scaled Euclidean length that belongs to the envelope of optimal solutions determined in the first step.

As with the case of full netting, this embodiment of the two steps of determining tax allocations of realized gains by partial netting is contained in code that invokes in interior point convex optimization algorithms of the art, CVX as the front-end for disciplined convex programming and its default solver SDPT3.

### Eliminating Layering Entirely, Making all Allocations, Including Dividends and Interest by Using Full/Partial Netting

### Methodology

The relevant U.S. Treasury Regulations [4,5] that describe the full and partial netting approaches do not confine themselves to allocation of realized capital gains only. U.S. partnerships have typically applied the full and partial netting approaches to the allocation of realized capital gains to partners. Items of income and expense of other than realized capital gains, including ordinary income, dividends, interest, investment expense, and foreign taxes, are allocated based on the layering methodology [3], which requires intensive bookkeeping to track these distributive items of income on a monthly or periodic basis and allocate them to partners according to the layering methodology.

The same methodologies of full and partial netting may be extended to allocate other distributive items of income, such as ordinary income, dividends, interest and expenses, simultaneously along with realized capital gains. The present invention formulates a two-step convex optimization problem in its embodiments, which produce a unique, robust and optimal tax allocation solution by harnessing efficient convex programming algorithms and software of the art.

Some experts might believe that by combining dividends and interest with capital gains in the tax allocation process, the resulting tax allocations may be skewed according to tax preferences of some partners. Further, there might be undesirable shifts or trade-offs between dividends/interest allocations and capital gains allocations among the partners.

The present invention has already resolved this source of concern by producing a unique, robust two-step tax allocation that dispel this fear. The second step resulting in scaled optimal tax allocations results in tax neutrality, in the sense that it precludes shifts or trade-offs between tax allocations of dividends/interest/expenses and tax allocations of capital gains.

### Generalizing the Partial Netting Methodology to Allocate all Distributive Items of Income

In this embodiment, we extend the present invention to allocate 4 items of partially netted realized capital gains defined according to the relevant Treasury Regulations [5], and 4 representative items of distributive income other than realized capital gains, namely dividends, interest, expenses and foreign taxes. Other distributive items are assumed to be zero, or allocated according to the methodology of layering and factored in to the input data on partner's book-tax capital account differences, denoted by ρ^{j}. ρ^{j} represents the book-tax capital account difference of each partner, before each ρ^{j} Thus, the embodiment of the invention described here may be easily extended to encompass all non-zero distributive items of income. The present embodiment also encompasses a situation where one of the distributive items of income, foreign tax, is not independent, and is constrained to bind to other independent items of income, dividends. The present invention in the embodiment shown here therefore extends the art to the construction of tax allocation of all non-zero items of distributive income that are not restricted to allocation according to the partnership agreement, and all dependent items of distributive income that are linked or bound to other independent items of distributive income. Indeed, this is the most generalized embodiment of the present invention, and the embodiments for the tax allocation of realized capital gains only by full and partial netting are special cases where other items of distributive income are zero or are allocated by the method of layering [3].

### Formulating the Convex Optimization Problem of Simultaneously Allocating Dividends, Interest, and Capital Gains Under the Partial Netting Methodology

We extend the formulation that we created for allocating realized short-term and long-term gains under partial netting to include four more items: dividends, interest, investment expense, and foreign tax paid. Our tax allocation decision vector x has 8M elements, 8 for each partner, denoted as x={Π₅^{j}, Π₆ₐ^{j}, Π_{8,L}^{j}, Π9a,L^{j}, Π8,G^{j}, Π_{9a,G}^{j}, Π_{13b}^{j}, Π₁₆ₗ^{j}}. The 4 elements Π_{8,L}^{j}, Π_{9a,L}^{j}, Π_{8,G}^{j}, Π_{9a,G}^{j} represent the partially aggregated short term and long term realized gains and losses that were encountered in the embodiment of partial netting earlier. The 4 additional elements Π₅^{j}, Π₆ₐ^{j}, Π_{13b}^{j}, Π₁₆ₗ^{j} represent partner allocation of dividends, interest, expenses and foreign taxes, respectively. These distributive items of income at the partnership level are Π₅, Π₆ₐ. Π_{13b}, and Π₁₆ₗ, respectively.

We represent our generalized partial netting objective function, the collective measure of book-tax disparities of the partners, as:

$$f ( x ) = ‖ {H}_{1} x - {g}_{1} ‖ , where {H}_{1} = [ \begin{matrix}{E}_{1} & ⋯ & {Z}_{1} \\ ⋮ & ⋱ & ⋮ \\ {Z}_{1} & … & {E}_{1}\end{matrix} ]$$

is an M by 8M coefficient block diagonal matrix containing the length 8 row vectors E₁=[1 1 1 1 1 1 1 1] along its block diagonals, and Z₁=[0 0 0 0 0 0 0 0] at all block off-diagonal locations.

We are given the column vector g₁ in advance, of each partner's book-tax difference before making the tax allocations of the partially aggregated items of realized gain, and before making tax allocations of dividends, interest, expenses and foreign taxes, but after making allocations of other items of taxable income according to the layering methodology [3]. The input data vector g₁ has elements, The elements of our vector g₁ of length M are:

g₁^{T}=[ρ¹ ρ² . . . ρ^{M}].

The first step convex optimization to solve for tax allocations of partially netted realized capital gains and 4 items of distributive income other than realized capital gains in this embodiment is stated as:

$${min}_{x} . f ( x ) = ‖ {H}_{1} x - {g}_{1} ‖ ,$$

which is written in expanded form as:

$$f ( x ) = {min . {\sum }_{j = 1}^{M} {[ {ρ}^{j} - ( {\prod }_{5}^{j} + {\prod }_{6 a}^{j} + {\prod }_{8 , L}^{j} + {\prod }_{9 a , L}^{j} + {\prod }_{8 , G}^{j} + {\prod }_{9 a , G}^{j} - {\prod }_{13 b}^{j} - {\prod }_{16 l}^{j} ) ]}^{2} \}}^{\frac{1}{2}}$$

by choice of partner allocations x={Π₅^{j}, Π₆ₐ^{j}, Π_{8,L}^{j}, Π9a,L^{j}, Π8,G^{j}, Π_{9a,G}^{j}, Π_{13b}^{j}, Π₁₆ₗ^{j}}

Our choice is subject to the 8M feasibility constraints that:

Π₅^{j}≧0 (M such constraints: interest allocations must be positive)

Π₆ₐ^{j}≧0 (M such constraints: dividend allocations must be positive)

Π_{8,G}^{j}≧0 (M such constraints: gain-making realized short-term gain tax lots must be positive)

Π_{8,L}^{j}≦0 (M such constraints: loss-making realized short-term gain tax lots must be negative)

Π_{9a,L}^{j}≦0 (M such constraints: loss-making realized long-term gain tax lots must be negative)

Π_{9a,G}^{j}≧0 (M such constraints: gain-making realized long-term gain tax lots must be positive)

Π_{13b}^{j}≦0 (M such constraints: expense allocations must be negative, because these are expressed as a negative number)

Π₁₆ₗ^{j}≦0 (M such constraints: foreign tax paid allocations must be negative, because these are also expressed as a negative number)

and subject to the eight aggregation additivity constraints that:

Σⱼ₌₁^{M}Π₅^{j}=Π₅

Σⱼ₌₁^{M}Π₆ₐ^{j}=Π_{6α}

Σⱼ₌₁^{M}Π_{8,G}^{j}=Π_{8,G}

Σⱼ₌₁^{M}Π_{8,L}^{j}=Π_{8,L}

Σⱼ₌₁^{M}Π_{9a,G}^{j}=Π_{9a,G}

Σⱼ₌₁^{M}Π_{9a,L}^{j}=Π_{9a,L}

Σⱼ₌₁^{M}Π_{13b}^{j}=Π_{13b}

Σⱼ₌₁^{M}Π₁₆ₗ^{j}=Π₁₆ₗ

In this embodiment, we demonstrate dependency of one of the elements in the decision vector being dependent on another through imposition a ninth set of M additional equality constraints, that foreign tax should be a fixed proportion of dividends, equal to

$$\frac{{Π}_{16 l}}{{Π}_{5}} = k .$$

This makes the {Π₁₆ₗ^{j}} redundant and may be eliminated from the formulation, to be modified to incorporate k. This constraint ensures that foreign taxes cannot be allocated to partners out of proportion to their dividends. The problem specification may be simplified by eliminating Π^{16l} entirely. Instead, we retain Π₁₆ₗ in the formulation thus far, and force its dependency by additional equality constraints to make Π₁₆ₗ redundant:

kΠ₅−Π₁₆ₗ=0 (M such equality constraints)

We have 8M unknowns to be solved for, subject to 8M+8+M constraints. This embodiment for partial netting provides the tax allocation solution vector x*, which is one of the many such vectors that achieves the global minimum of book-tax disparities ƒ(x*).

In the second step, the tax allocation vector is denoted by z, so as to distinguish it from x in the first step. We now need to scale z, by dividing each element by the respective partner's optimal tax allocation vector elements H₁x* of length M that was derived from the optimal solution x* in the first step. In compact matrix form, we may derive the length 8M scaling vector xopt2=Hx*, where x* is an optimal tax allocation solution obtained in the first step, and H is the block diagonal matrix

$$H = [ \begin{matrix}E & ⋯ & Z \\ ⋮ & ⋱ & ⋮ \\ Z & … & E\end{matrix} ]$$

where E is a 4×4 matrix of ones along the block diagonal, and Z is a 4×4 matrix of zeros at all other block off-diagonal positions. H is also one-half times the Hessian corresponding to our convex objective function, and its positive semi-definite nature is proof of convexity of the objective function.

We scale our decision vector z by dividing each element of z by the corresponding element of xopt2. Consistent with coding notation in the art for scaling vector elements, we shall denote this as (z)./(xopt2). The ./operator, introduced previously, divides the first element of z by the first element of xopt2, and so on. The second step objective function is to choose z so as to minimize ƒ₂(z)=∥(z)./(xopt2)∥, that is, we wish to find z with the smallest scaled 2-norm that belongs to the envelope or set of first step optimal solutions. Note that the vector xopt2, which was obtained from the first step solution x*, is a fixed parameter for the second step.

The original feasibility constraint set is extended by placing additional constraints that require the second step optimal solution to belong to the envelope of optimal solutions. For M−1 partners, we establish the vector H₂x* with j=1 . . . M−1 elements. The matrix H₂ is same as the matrix H₁x* with its last row omitted, making H₂ a matrix with M−1 rows and M columns. Note that xopt1 collapses the repeated elements in xopt2, but skips the last partner.

The additional constraints that define an envelope of first step optimal solutions that must be satisfied by any second step optimal solution z are:

H₂z=H₂x* with M−1 elements.

The second step convex optimization problem to determine a unique and robust tax allocation solution that also minimizes the collective book-tax disparities of the partners is stated as:

$${min}_{z} . {f}_{2} ( z ) = ‖ z . / xopt 2 ‖$$

where, is the z is the tax allocation vector of length 8M,−;

The same 8M+8+M constraints as in the first step apply and are not repeated here;

expressed compactly in matrix form as:

H₂z=xopt1

This embodiment in the second step produces an optimal tax allocation vector z* that represents tax allocations of realized capital gains under the method of partial netting which is unique, robust, and optimal, being the tax allocation vector of the smallest scaled Euclidean length that belongs to the envelope of optimal solutions determined in the first step.

As with the case of full netting, this embodiment of the two steps of determining tax allocations of realized gains by partial netting is contained in code that invokes in interior point convex optimization algorithms of the art, CVX as the front-end for disciplined convex programming and its default solver SDPT3. The art of interior point methodology to obtain solutions to convex problems is highly scalable. A standard desktop personal computer of 2007 vintage running CVX with SDPT3 embodying this convex optimization problem of allocating 8 items of distributive income with M=100 partners, leading to 800 decision variables with 908 constraints for the first step was solved with 17 iterations in 0.88 seconds for the first step. The second step, also with 800 variables, with 1007 constraints was solved with 35 iterations in 5.42 seconds second step. The art of disciplined convex programming [7] and interior point algorithms to solve convex programming problems [8] has advanced substantially relative to earlier art. The present invention harnesses these advancements in the art of solving convex programming problems and provides a disciplined convex programming set-up, formulation, and embodiment for partnership tax allocation that is hitherto not present in the art, to simultaneously obtain optimal tax allocations of distributive items of income other than capital gains and realized capital gains for partnerships that minimize the collective book-tax disparities of the individual partners within seconds.

One skilled in the art will appreciate that various modifications or applied examples are conceivable which are within the scope of this invention. Accordingly, the scope of this invention is not limited to the previously-described embodiments.

### REFERENCES

[1] Internal Revenue Code 26 U.S.C. §704 (b).
[2] Treasury Regulations 26 C.F.R. §1.704-1(b)(2).
[3] Treasury Regulations 26 C.F.R Section 1.704-1(b)(5), Example 13(iv).
[4] Treasury Regulations 26 C.F.R. §1.704-3 (e)(3)(v) and (vi).
[5] Treasury Regulations 26 C.F.R. §1.704-3 (e)(3)(iv) and (vi).
[6] Bellamy, C. “Tax Allocations for Securities Partnerships,” The Tax Adviser, Aug. 1, 2003, pp. 472-476. This article is also online at http://www.aiepa.org/pubs/taxadv/online/aug2003/clinic 7.htm.
[7] Michael Grant, Stephen Boyd and Yinyu Ye, “Disciplined Convex Programming,” in Leo Liberti and Nelson Maculan (ed.) “Global Optimization: From Theory to Implementation”, Springer US, 2006, pages 155-200. Instructions, manuals and downloads of CVX open-source software based on this methodology are provided at http://w ww.stanford.edu/˜boyd/cvx/.
[8] R. H Tutuncu, K. C. Toh, and M. J. Todd, “Solving semidefinite-quadratic-linear programs using SDPT3,” Mathematical Programming Ser. B, 95 (2003), pp. 189-217. Open-source SPDT3 software is provided at lift http://www.math.cmu.edu/˜reha/sdpt3.html.
[9] Stephen Boyd and Lieven Vandenberghe, Convex Optimization (Cambridge University Press, U.K., 2004, p. 244.

1. In a computer system a method for allocating fully netted realized gains and losses to partners according to the Full Netting approach as described in Treasury Regulations [3], which requires the allocation of net tax gain (or net tax loss) to the partners in a manner that reduces the book-tax disparities of the individual partners, but also preserves the tax attributes of each item of gain or loss of the partnership, and not be determined with a view to reducing the present value of partners' aggregate tax liability, comprising the steps of: inputting data for the net realized short term tax gains or losses of the partnership, the net realized short term gains of the partnership, partners' book capital accounts, partners' tax capital accounts after all current and prior tax allocations except realized short term and long term gains; providing a processor programmed to perform a routine that provides an optimization which utilizes the input data; wherein the routine provides tax allocations of the partnership's realized long term and short term gains to partners; wherein the processor is further programmed to output the tax allocations; wherein the routine performed by the processor includes a first step of optimization, and a second step, the two steps executed automatically without any user interaction; wherein the first step provides for running the optimization routine using the input data to derive a condition that the plurality of optimal tax allocation solutions should meet; wherein the first step does not necessarily provide a unique or robust optimal solution; wherein the second step includes: taking the results from the first step as input, along with the same input data applied in the first step, then running a different optimization routine, using the same input data as the first step in addition to and the result of the first step, to identify the optimal tax allocation solution that conforms to the Treasury Regulations [3] that describe Full Netting.

2. The method of claim 1, further including: a method for allocating partially netted realized gains and losses according to the Partial Netting approach as described in Treasury Regulations [4], comprising the inputting data for the partially netted short realized term gains, partially netted short realized term losses, partially netted long realized term gains and partially netted long realized term gains realized losses, and the same partner input data in the method of claim 1; providing a processor programmed to perform a two step routine analogous but not identical to the method of claim 1, that identifies the optimal tax allocation solution that conforms to the Treasury Regulations [4] that describe Partial Netting.

3. The methods of claims 1 and 2, further including: a method for allocating all items of realized income of the partnership, including dividends, interest, and expenses, and including any other item of realized income of the partnership, in addition to realized gains and losses whether fully or partially netted, comprising the inputting data for all items of distributive income of the partnership, including fully or partially netted realized gains of the partnership in the method of claim 1; providing a processor programmed to perform a routine analogous but not identical to the method of claim 1 or 2, that identifies the optimal tax allocation solution that conforms to the Treasury Regulations [3,4] that describe Full and Partial netting.
